(19) United States
(12) Patent Application Publication
(10) Pub. No.: US 2009/0182827 A1
(43) Pub. Date: Jul. 16, 2009

(54) METHOD AND APPARATUS FOR THE AGGREGATION AND INDEXING OF MESSAGE PARTS IN MULTIPART MIME OBJECTS

(75) Inventor: Imed Bouazizi, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/247,954

(22) Filed: Oct. 8, 2008

Related U.S. Application Data
(60) Provisional application No. 60/981,086, filed on Oct. 18, 2007.

(51) Int. Cl. G06F 15/16

(52) U.S. Cl. 709/206

(57) ABSTRACT

An indexing mechanism for multipart messages, such as multipart Multipurpose Internet Mail Extensions (MIME) multipart messages, which contain several parts from different objects. The indexing enables an identification of the content of the message and the fast locating of a specific part in a multipart MIME container. When a multipart MIME with subtype “related” is used for aggregating parts of different messages, the indexing may choose to list only the generic parts of each message. Each generic part will reference the other related parts so as to enable the extraction of all related parts of a specific message in an efficient manner.

### CROSS-REFERENCE TO RELATED PATENT APPLICATIONS

This application claims priority from Provisional Application U.S. Application 60/981,086, filed Oct. 18, 2007, incorporated herein by reference in its entirety.

### FIELD OF THE INVENTION

The present invention relates generally to the preparation and transmission of notification messages for informing a receiver of new events and/or triggering interactivity among devices.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Digital Video Broadcasting Convergence of Broadcast and Mobile Services (DVB CBMS) is currently working on a notification framework for Internet Protocol Datacast (IPDC) over Digital Video Broadcasting-Handheld (DVB-H). The notification framework will provide methods for carrying notification messages, informing a receiver of new events or triggering interactivity. The notification messages are to be carried over the broadcast channel DVB-H or over the interactivity channel (e.g., a 3G network).

Notification messages typically comprise a number of parts. A generic part is consumed by the notification framework and carries information that enables the extraction, filtering, and processing of the notification message. An application-specific part is consumed by the notification application and is therefore application-specific. The application-specific part contains information about the event that is notified to the receiver or user. An example of a use scenario involves a voting application, where the application-specific part carries information about the voting. Auxiliary data comprises the other notification message parts, e.g., audio or video clips. Those parts are typically media objects which are used for the presentation or execution of the notification message.

For notification messages related to a regular service (e.g., a mobile TV channel), synchronization is achieved by transport over Real-time Protocol (RTP). In order to enable fast access, the complete message is carried over RTP. Alternatively, only the generic message part is carried over RTP, which would enable synchronization. The generic message part points to the application-specific message part, as well as any other media object that is part of the notification message. The other message parts are then carried over a File Delivery over Unidirectional Transport (FLUTE) that session that is referred to by the generic message part. FLUTE is described in detail in the Internet Engineering Task Force (IETF) Request for Comments (RFC) 3926, which is discussed in detail at www.ietf.org/rfc/rfc3926.txt!number=3926.

Stand-alone notification services are carried over FLUTE. A stand-alone notification service is a notification service that is not related to another service. An example of a stand-along notification service is a stock market ticker. An example of a service-related notification channel is a voting service that is related to a particular television show. Notification services are aggregated e.g., when carrying multiple notification messages that are close to each other in their presentation time and small in size. An example is a news notification service, where each piece of news represents a notification message. Several news messages can be aggregated together and carried as a single object.

Notification messages are of different sizes. The size of notification messages can range from very small messages to very large messages, including different media objects such as video clips and images. Recently, a method for encapsulating message parts of the same notification message has been proposed. The encapsulation is performed using the Multipart Internet Mail Extensions (MIME) multipart container format. The root parts of the message corresponds to the generic message part described above.

As mentioned previously, some notification messages are small in size. In such cases, their transmission as single objects will result in very high amount transport overhead. As an example, a news feedback notification service carries small pieces of news as notification objects. Each piece of news contains a title and a short summary of the story, along with a link to the full story. Sending each piece of news separately as soon as it becomes available is not efficient. Instead, news information will be collected for a given period of time and then sent as a single object. Assuming that each piece of news is mapped to a notification message, an aggregation mechanism for putting a set of notification messages into a single transport object is required.

A MIME multipart message contains a boundary in the “Content-type:” header. This boundary, which must not occur within any of the parts, is placed between the parts, and at the beginning and the end of the body of the MIME multipart message, as follows:

MIME-version: 1.0
Content-type: multipart/mixed; boundary=“boundary”
This is a multi-part message in MIME format.
--boundary
Content-type: text/plain
This is the body of the message.
--boundary
Content-type: image/jpeg
Content-Transfer-Encoding: base64
Content-Description: picture
VGhpcyBpcyB0aGUgYm9keSBvZiB0aGUgbWVzc2FnZS48L3A+CiAgPC9ib2R5P
go8L2h0bWw+Cg==
--boundary—

Each part comprises its own content header (zero or more Content-header fields) and a body. The example provided above shows a content header that indicates the MIME type of the message part, a content header for the transfer encoding, and a content header that contains a free description of the message part.

The MIME standard defines various multipart-message subtypes. These subtypes specify the nature of the message parts and their relationship to one another. The subtype is specified in the “Content-Type” header of the overall message. For example, a multipart MIME message using the related subtype would have its Content-Type set as “multipart/related”.

IETF RFC 1521 (MIME Part One: Mechanisms for Specifying and Describing the Format of Internet Message Bodies; September 1993) (available at www.ietf.org/rfc/rfc1521.txt?number=1521) initially defined 4 subtypes—mixed, digest, alternate and parallel. Each of these subtypes is discussed below. Additional subtypes have since been separately defined in other RFCs.

Multipart/mixed is used for sending files with different “Content-Type” headers inline (or as attachments). The default content-type for each part is “text/plain”. The mixed subtype is defined in IETF RFC 2046 (Multipurpose Internet Mail Extensions (MIME) Part Two: Media Types; November 1996) (available at www.ietf.org/rfc/rfc2046.txt?number=2046).

Multipart/related is used to indicate that message parts should not be considered individually, but rather as parts of an aggregate whole. The message comprises a root part (by default, the first) which references the other parts inline. The other parts may in turn reference other parts. Message parts are commonly referenced by the “Content-ID” part header. The syntax of a reference is unspecified and is instead dictated by the encoding or protocol used in the referring part. The related subtype is defined in RFC 2387 (The MIME Multipart/Related Content-type; August 1998) (available at www.ietf.org/rfc/rfc2387.txt?number=2387.)

A multipart/encrypted message has two parts. The first part has control information that is needed to decrypt the application/octet-stream second part. The encrypted subtype is defined in RFC 1847 (Security Multiparts for MIME: Multipart/Signed and Multipart/Encrypted; October 1995) (available at www.ietf.org/rfc/rfc1847.txt?number=1847).

The aggregation of message parts of different notification messages into a single container is necessary in order to reduce the overhead of transport protocols for the case of small notification messages. The multipart MIME format is to be used for the encapsulation of notification messages. A possible subtype of the multipart MIME to be used for encapsulating notification messages is the “related” subtype. The related subtype indicates that the different parts of the container are related to each other.

To extract a specific notification message, the receiver has to go through all of the different parts of the multipart MIME message and look for the generic message part of the notification message of interest. It then has to look for the other parts of the message by parsing the message header. In case it has to perform filtering, the filtering criteria are provided in the File Delivery Table (FDT) according to FLUTE protocol, not in the notification message itself.

In the above arrangement, several issues arise. For example, the parsing procedure is lengthy due to the unclear structure of the container. Additionally, the filtering criteria and other related message information result in very large FDT, if all of this information is placed in the FDT. Still further, in this arrangement, it is not known which message parts belong to which message.

A mechanism has been developed for encapsulating parts of a notification message into a single container using multipart MIME with subtype related. However, this arrangement does not consider the case of aggregating multiple notification messages into a single container. A notification message as illustrated in FIG. 1 below has a generic message part, which contains generic attributes of the notification message, e.g., the type of the notification message. As discussed previously, this generic message part is common to all notification messages and is consumed by the notification framework (not by the notification application). Previous arrangements do not define how to refer to the other parts of the notification message such as, for example, one or more application-specific message parts and zero or more media objects relating to the application-specific message parts. In the case of aggregation of multiple messages into a single container, it is unknown which part belongs to which message.

### SUMMARY OF THE INVENTION

Various embodiments provide an indexing mechanism for multipart messages, such as multipart Multipurpose Internet Mail Extensions (MIME) multipart messages, which contain several parts from different objects. The indexing enables an identification of the content of the message and the fast locating of a specific part in a multipart MIME container. When a multipart MIME with subtype “related” is used for aggregating parts of different messages, the indexing may choose to list only the generic parts of each message. Each generic part references the other related parts so as to enable the extraction of all related parts of a specific message in an efficient manner.

Various embodiments discussed herein allow for the aggregation of multiple messages into a single multipart MIME container. The indexing allows for the fast localization of the message parts. Additionally, the inclusion of additional information about the notification message into the index list allows for fast access to this information. This is useful, for example, in the case of filtering information that helps the receiver to select the notification messages in which the receiver is interested.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an example of a conventional notification message structure;

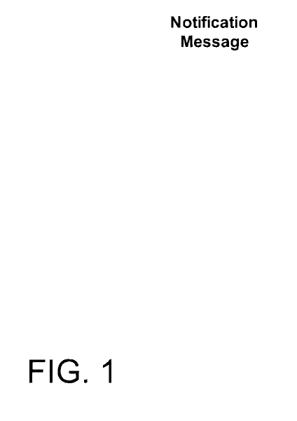

FIG. 2 is a representation showing the aggregation of different messages into a multipart MIME container according to various embodiments;

FIG. 3 is a representation of an example multipart MIME container;

FIG. 4 is a representation of an example generic message part referencing and message part transport operation;

FIG. 5 is an overview diagram of a system within which various embodiments may be implemented;

FIG. 6 is a perspective view of an electronic device that can be used in conjunction with the implementation of various embodiments of the present invention; and

FIG. 7 is a schematic representation of the circuitry which may be included in the electronic device of FIG. 6.

### DETAILED DESCRIPTION OF VARIOUS EMBODIMENTS

Various embodiments provide an indexing mechanism for multipart MIME messages which contain several parts from different objects. The indexing enables an identification of the content of the message and the fast locating of a specific part in a multipart MIME container. When a multipart MIME with subtype “related” is used for aggregating parts of different messages, the indexing may choose to list only the generic parts of each message. Each generic part will reference the other related parts of the message so as to enable the extraction of all related parts of a specific message in an efficient manner.

Various embodiments discussed herein allow for the aggregation of multiple messages into a single multipart MIME container. The indexing allows for the fast localization of the message parts. Additionally, the inclusion of additional information about the notification message into the index list allows for fast access to this information. This is useful, for example, in the case of filtering information that helps the receiver to select the notification messages in which the receiver is interested.

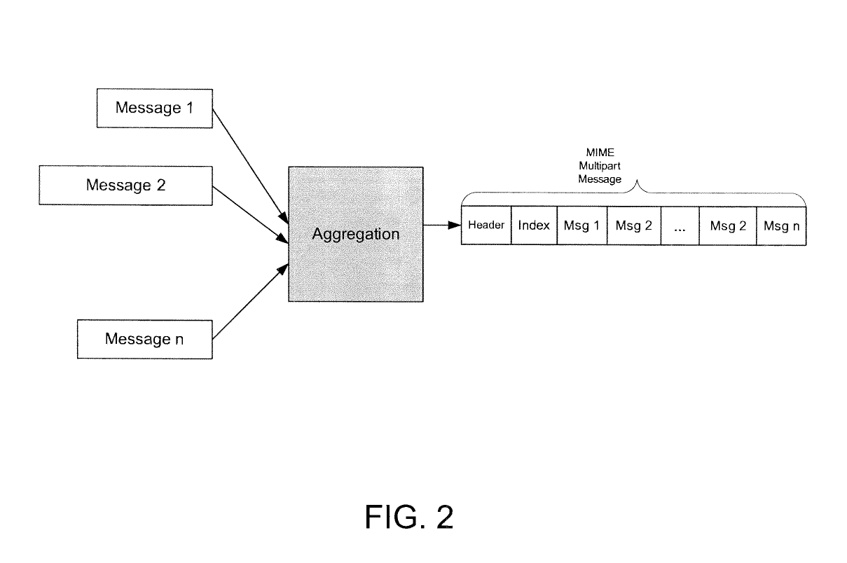

FIG. 2 is a representation showing the aggregation of different messages into a multipart MIME container according to various embodiments. As shown in FIG. 2, the parts of each notification message may appear as contiguous parts in certain embodiments. However, it is also for the parts of a single notification message to not necessarily appear as contiguous blocks in the multipart MIME message. Instead, the individual parts can be interleaved with parts of other notification messages.

Various embodiments use this indexing structure with extensions to include information about the notification messages, such as filtering information, within the index. This enables faster access to that information (e.g., the quick filtering of notification messages).

The indexing of parts of a multipart MIME message can be performed by specifying the part number of the message. Each message part starts with an indicated boundary string. This is followed by a header, which is followed by an empty line and then the payload. A is capable of locating the boundary string by parsing the multipart MIME container.

In one example implementation, each occurrence of the boundary string is mapped to a number, starting from 0 or 1 and increasing by one. In various embodiments ‘0’ may be allocated to the boundary at the beginning of the multipart MIME message preceding the first part or to the boundary in the multipart MIME message header. Each message part is mapped to an index value. In one embodiment, the multipart mime header may be addressed with index 0, but this action is not required in various embodiments. The number is then indicated in the index list as the multipart MIME number. If the boundaries within the message that have the similar form for all message parts do not carry these numbers, then the desired part can be found in one embodiment by looking for a boundary line of interest. There is no need to parse the header to discover the content-ID, but it is sufficient to skip n-−1 boundary headers and start reading after the n^{th} boundary header to locate the n^{th} part of the multipart MIME message. A parser can immediately jump to that given part and extract the payload. This saves time for the receiver, as it does not have to jump from part to part and check the header to identify the part of interest.

When using the “related” subtype of the multipart MIME, the root part of the message is assumed to be the first part that appears in the message payload. Alternatively, the root part is indicated in the header of the multipart MIME message. If multiple notification messages are aggregated into a single container, no root of the multipart MIME container can be identified, as each notification message will have its own root part. The index structure addresses this issue, as it acts as root part for the aggregated container.

Several pieces of information about a notification message or message part need to be indicated to the receiver of the container. Examples of such pieces of information include the message ID, version number, filtering criteria, etc . . . This information needs to be accessed in a fast way in order to enable the quick extraction and processing of the notification message. By having flexible and extensible index list syntax, the necessary information relating to a specific part of the multipart MIME object can be added. In this manner, the receiver immediately obtains get the necessary information by parsing the index structure.

In various embodiments, the index structure is inserted as the root part of a multipart MIME related message. The index is the entry point to parsing the message. The index provides a list of the different parts that are found in the message, as well as some additional information about that part and, optionally, the part's location in the message. The structure of the index list can be XML-based in certain embodiments. The following is an example of the syntax of index lists.

<?xml version=″1.0″ encoding=″UTF-8″?>

<xs: schema xmlns:xs=″http://www.w3.org/2001/XMLSchema″

xmlns:fl=″dvb:ipdc:2007:notification″
elementFormDefault:xs=″qualified″
targetNamespace:xs=″ dvb:ipdc:2007:notification ″>

<xs:element name=″MultipartIndex″>

<xs:complexType>

<xs:sequence>

<xs:element name=″MessagePart″ type=“MessagePartType“/>
<xs:any namespace=″##any″ processContents=″lax″/>

</xs:sequence>

<xs:anyAttribute namespace=″##any″ processContents=″lax″/>

</xs:complexType>
</xs:element>
<xs:complexType name=″MessagePartType″>

<xs:sequence>

<xs:any namespace=″##any″ processContents=″lax″/>

</xs:sequence>
<xs:attribute name=″Content-ID″ type=″xs:anyURI″ use=″required″/>
<xs:attribute name=″Content-Position″ type=″nonNegativeInteger″ use=″optional″/>
<xs:attribute name=”Content-Type” type=″xs:string″ use=″optional″/>
<xs:attribute name=”Content-Transfer-Encoding” type=″xs:string″ use=″optional″/>
<xs:attribute name=”Content-Description” type=″xs:string″ use=″optional″/>
<xs:anyAttribute namespace=″##any″ processContents=″lax″/>

</xs:complexType>

</xs:schema>

The index list schema is extensible, and new elements and attributes may be added to the original structure. One such attribute or extension involves the addition of an identifier of the notification message and e.g., certain filtering criteria for that message. This index list is not intended to only be used for notification messages. In fact, the index list can be used for any other type of content or application.

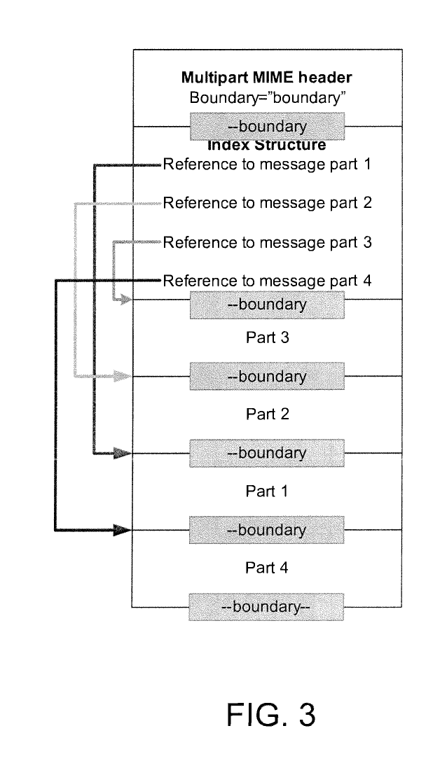

The following is an example of an instantiated index list. The corresponding multipart MIME message is depicted in FIG. 3.

<?xml version=“1.0” encoding=“utf-8”?>
<MultipartIndex>

<MessagePart Content-ID=“part1” Content-Position=“3”
Content-Type=“video/3gp”/>
<MessagePart Content-ID=“part2” Content-Position=“2”
Content-Type=“audio/mp3”/>
<MessagePart Content-ID=“part3” Content-Position=“1” Content-

Type=“application/dvb.ipdc.notif+xml”/>

<MessagePart Content-ID=“part4” Content-Position=“4”
Content-Type=“text/xml”/>

</MultipartIndex>

The generic message part of a notification message is the entry point to the message and is processed by the notification framework. The generic message part contains information of various types. For example, the generic message part contains timing information relating to concepts such as start or launch time, end or removal time, duration time, validity or lifetime. One or more of these types of timing information may be used. The generic message part also includes subscription information, examples of which may include information on how to subscribe, where to subscribe, whether the subscription is a one-time subscription or a permanent or time-limited subscription, and whether the subscription is related to the subscription of other items. The generic message part may also include references to the ESG or service. The notification message may in various embodiments refer to service identification, to content identification or to other identifiable items or entities.

In one embodiment, the generic message part may be transmitted separately from the other message parts. For example, the generic message part may be transmitted over RTP, while the rest of the message over FLUTE. In other embodiments, the generic message part may or may not be transmitted in the multipart MIME message. Several messages may also be aggregated into a single container. In both situations, the receiver needs to recover the message by collecting its different pieces together.

In various embodiments, the generic message part is extended to include references to the other message parts. This serves to facilitate the reconstruction of the notification messages out of its parts. In one embodiment, the reference may be used by a notification framework for collecting all of the parts of the notification message and for forwarding them to a notification application. This arrangement also removes any confusion regarding which part belongs to which message. In various embodiments, each message part is identified with a URI that is unique within the transport session. The generic message part is extended to contain references to the rest of the message parts. The reference is a URI which is used to locate the referenced part. If the referenced part is carried over FLUTE as a single transport object, then it corresponds to the content location in the FDT. If the referenced part is carried in a multipart mime container, then it corresponds to the Content-ID header of the multipart mime part. The generic message part itself is identified by its “Content-Type” field and the message id and version. An example XML schema of the message part is as follows.

<?xml version=″1.0″ encoding=″UTF-8″?>

<xs:schema xmlns:xs=″http://www.w3.org/2001/XMLSchema″

xmlns:fl=″dvb:ipdc:2007:notification″
elementFormDefault:xs=″qualified″
targetNamespace:xs=″ dvb:ipdc:2007:notification
″>

<xs:element name=″NotificationDescription″>

<xs:complexType>

<xs:sequence>

<xs:element name=″NotificationPaylaodRef″
type=″xs:anyURI″

minOccurs=″0″/>

<xs:element name=″mediaObjectRef″
type=″xs:anyURI″ minOccurs=″0″

maxOccurs=″unbounded″/>

<xs:anyAttribute namespace=″##any″
processContents=″lax″/>

</xs:sequence>
<xs:attribute name=”Message-ID”
type=″xs:anyURI″ use=″optional″/>
<xs:attribute name=”Message-Version”
type=″xs:nonNegativeInteger″

use=″optional″/>

<xs:anyAttribute processContents=″skip″/>

</xs:complexType>

</xs:element>

</xs:schema>

The generic message part may contain up to one reference to the application-specific notification message part. The generic message part may also contain an unlimited number of references to other media objects that constitute part of the notification message. The generic message part is identified by the notification message ID and version, which may be included in the generic message part or may be part of the transport protocol headers.

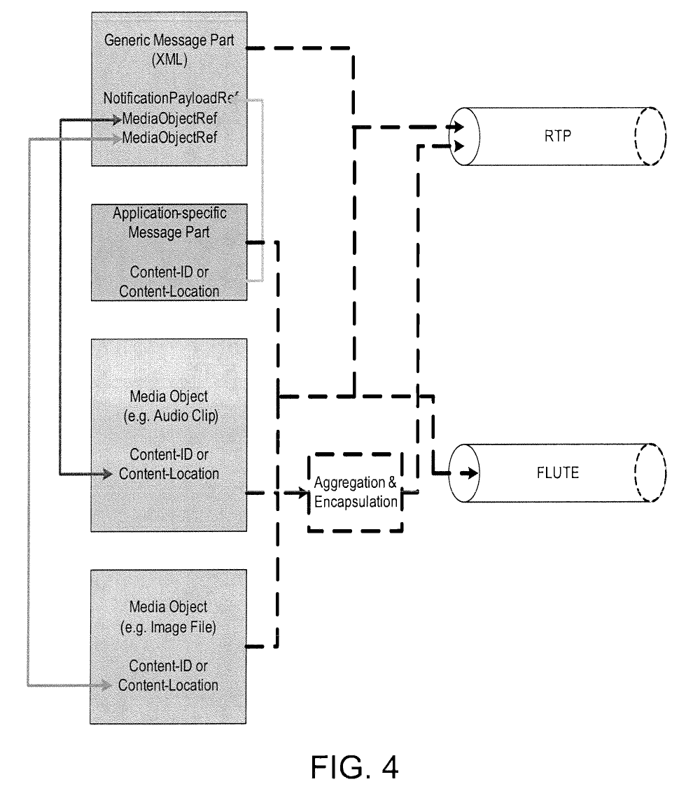

The following is an example of a generic message part XML fragment. The corresponding message structure is depicted in FIG. 4.

<?xml version=“1.0” encoding=“utf-8”?>
<NotificationDescription Message-ID=“ service1:msg1” Message-Version=“2”>

<NotificationPayloadRef>service1:msg1:app1</NotificationPayloadRef>
<MediaObjectRef>service1:msg1:obj1</MediaObjectRef>
<MediaObjectRef>service1:msg1:obj2</MediaObjectRef>

</NotificationDescription>

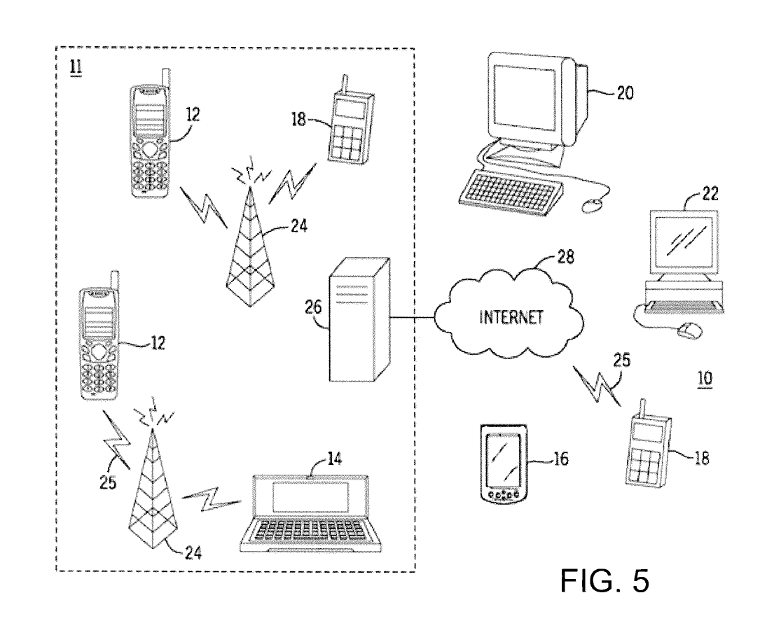

FIG. 5 shows a system 10 in which various embodiments can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 5 includes a mobile communications network 11 and the Internet 28. The communications network 11 may be a mobile telephone network, a digital broadcast broadband network or any other similar communications network and combinations thereof. The communication between entities of the communications network 11 may be unidirectional or bidirectional. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile electronic device 50 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the communications 11 and the Internet 28. The system 10 may include additional communication devices and communication devices of different types.

Communication devices of the various embodiments discussed herein may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

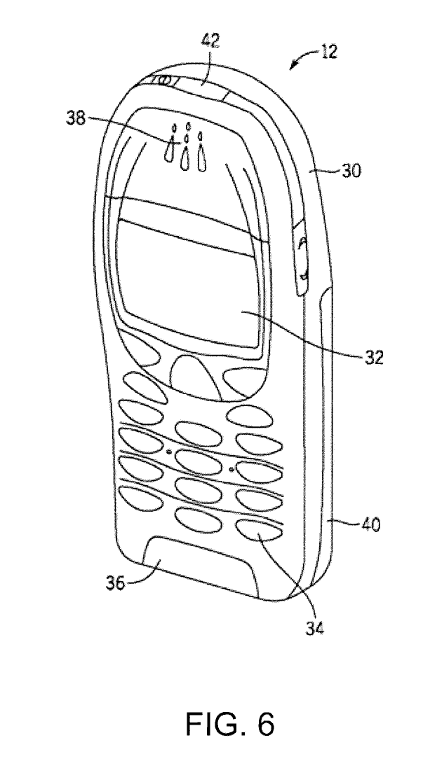

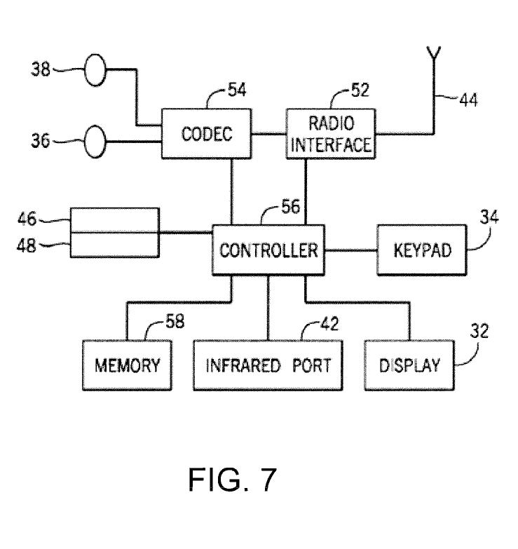

FIGS. 6 and 7 show one representative mobile device 12 within which various embodiments may be implemented. Any and all of the devices described herein may include any and/or all of the features described in FIGS. 6 and 7. It should be understood, however, that the present invention is not intended to be limited to one particular type of electronic device. The mobile device 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

The various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1 A method, comprising:
encapsulating at least one message into a message container, each of the at least one message including multiple parts;
inserting an index structure into the message container, the index structure usable by a remote device for parsing each part of the at least one message; and
transmitting the message container including the index structure to the remote device.

2. The method of claim 1, wherein the message container comprises a Multipurpose Internet Mail Extensions multipart message.

3. The method of claim 1, wherein the index structure includes a list of parts in the at least one message.

4. The method of claim 1, wherein the index structure includes information concerning a location of each part in the message container.

5. The method of claim 1, wherein the index structure is included as a root part of the message container.

6. The method of claim 1, wherein the index structure indicates boundaries between individual parts within the at least one message.

7. The method of claim 1, wherein the message container includes a generic part, and wherein the generic part is transmitted using a different protocol than is used to transmit other parts of the message container.

8. A computer program product, embodied in a computer-readable storage medium, comprising computer code configured to implement the processes of claim 1.

9. An apparatus, comprising:
a processor; and
a memory unit communicatively connected to the processor and including:
computer code for encapsulating at least one message into a message container, each of the at least one message including multiple parts;
computer code for inserting an index structure into the message container, the index structure usable by a remote device for parsing each part of the at least one message; and
computer code for transmitting the message container including the index structure to the remote device.

10. The apparatus of claim 9, wherein the message container comprises a Multipurpose Internet Mail Extensions multipart message.

11. The apparatus of claim 9, wherein the index structure includes a list of parts in the at least one message.

12. The apparatus of claim 9, wherein the index structure includes information concerning a location of each part in the message container.

13. The apparatus of claim 9, wherein the index structure is included as a root part of the message container.

14. The apparatus of claim 9, wherein the index structure indicates boundaries between individual parts within the at least one message.

15. The apparatus of claim 9, wherein the message container includes a generic part, and wherein the generic part is transmitted using a different protocol than is used to transmit other parts of the message container.

16. An apparatus, comprising:
means for encapsulating at least one message into a message container, each of the at least one message including multiple parts;
means for inserting an index structure into the message container, the index structure usable by a remote device for parsing each part of the at least one message; and
means for transmitting the message container including the index structure to the remote device.

17. The apparatus of claim 16, wherein the index structure indicates boundaries between individual parts within the at least one message.

18. A method, comprising:
receiving from a remote device a message container including:
at least one message, each of the at least one message including multiple parts; and
an index structure; and
using the index structure to parse each part of the at least one message.

19. The method of claim 18, wherein the message container comprises a Multipurpose Internet Mail Extensions multipart message.

20. The method of claim 18, further comprising using the index structure to identify a list of parts in the at least one message.

21. The method of claim 18, further comprising using the index structure to identify a location of each part in the message container.

22. The method of claim 18, wherein the index structure is included as a root part of the message container.

23. The method of claim 18, wherein the index structure indicates boundaries between individual parts within the at least one message.

24. The method of claim 18, wherein the message container includes a generic part, and wherein the generic part is received over a different protocol than is used to receive other parts of the message container.

25. A computer program product, embodied in a computer-readable storage medium, comprising computer code configured to implement the processes of claim 18.

26. An apparatus, comprising:
a processor; and
a memory unit communicatively connected to the processor and including:
computer code for processing a message container received from a remote device, the message container including:
at least one message, each of the at least one message including multiple parts; and
an index structure; and
computer code for using the index structure to parse each part of the at least one message.

27. The apparatus of claim 26, wherein the message container comprises a Multipurpose Internet Mail Extensions multipart message.

28. The apparatus of claim 26, wherein the memory unit further comprises computer code for using the index structure to identify a list of parts in the at least one message.

29. The apparatus of claim 26, apparatus of claim 26, wherein the memory unit further comprises computer code for using the index structure to identify a location of each part in the message container.

30. The apparatus of claim 26, wherein the index structure is included as a root part of the message container.

31. The apparatus of claim 26, wherein the index structure indicates boundaries between individual parts within the at least one message.

32. The apparatus of claim 26, wherein the message container includes a generic part, and wherein the generic part is received over a different protocol than is used to receive other parts of the message container.

33. An apparatus, comprising:
means for receiving from a remote device a message container including:
at least one message, each of the at least one message including multiple parts; and
an index structure; and
means for using the index structure to parse each part of the at least one message.

34. The apparatus of claim 33, wherein the index structure indicates boundaries between individual parts within the at least one message.
